(19) United States
(12) Patent Application Publication
(10) Pub. No.: US 2011/0314112 A1
(43) Pub. Date: Dec. 22, 2011

(54) Handling of Communication Session Invitations

(75) Inventors: Jan Erik Lindquist, Alvsjo (SE); Erik Rolin, Alvsjo (SE)

(73) Assignee: TELEFONAKTIEBOLAGET LM ERICSSON (PUBL), Stockholm (SE)

(21) Appl. No.: 13/144,779

(22) PCT Filed: Jan. 20, 2009
(86) PCT No.: PCT/SE2009/050052

§ 371 Date: Jul. 15, 2011

(51) Int. Cl. G06F 15/16

(52) U.S. Cl. 709/206

(57) ABSTRACT

The invention is directed towards improving the handling of communication session invitations in a communication network. In the network (N) a communication session control device (10) receives an invitation (I1) for an end user to engage in a communication session, sends a corresponding invitation message (I2) according to an invitation prioritizing scheme (PS) to a group (S1) of end user terminals (16, 18, 20) and receives, from one terminal (16), a response (R) providing a selection of a group related device (22). Based on the response it then disrupts sending invitation messages (12) and initiates involvement of the group related device (22) in the communication session. The end user terminal (16) receives the invitation message (I2), receives a user selection of the group related device (22) and sends the response (R) addressed to the communication session control device (10).

### TECHNICAL FIELD

The present invention relates to the handling of session invitations in communication networks. The invention more particularly relates to methods, apparatuses and computer program products for end-user control of session notification in a forking scenario where several end user terminals belongs to the communication network.

### BACKGROUND

In wide area communication networks that operate according to various communication protocols, for instance according to the SIP (Session Initiation Protocol) it is known to set up communication sessions, like voice or video communication sessions, between various end user terminals. Typically then an end user of one end user terminal, who may be considered as a session initiator, then wants to connect to an end user terminal of another end user.

As this is done the end user terminal of the session initiator sends an invitation to join the session through the network and destined to one or more end user terminals of the other end user. In systems that operate according to SIP and similar type of protocols, the control of communication on behalf of the end user terminal of this other end user is performed by a communication session control device, which is typically a device that implements the S-CSCF (Serving Call Session Control Function) functionality defined by 3GPP. This device may typically be provided through a server.

Now, it is possible that the end user who receives the invitation does possess a number of different end user terminals, which he/she may use in various ways in relation to the communication session. Some may be possible to use for sending or receiving data in the communication session, like for instance used for sending or receiving speech data, while others may not be possible to use for sending or receiving data in the session. However, it is possible to respond to an invitation to join a communication session with all these end user terminals. This means that they are all more or less able to indicate in which way the invitation is to be handled, like if the invitation is to be declined, accepted or if the invitation is to be forwarded to some other device or end user terminal.

It is the task of the communication session control device to control in which way the invited end user is to be alerted or notified using the different end user terminals that are at his/her disposal. Alerting or notification is here typically started through sending an invitation message that corresponds to the invitation sent by the session initiator. This invitation message is then sent according to an invitation prioritizing scheme being set for the end user terminals of the invited end user. This means that the invitation message is sent to the end user terminals in a pre-determined order and being presented to the invited end user via the end user terminals in the prioritizing order. This process is also called forking.

Typically if an end user then answers to the invitation in an affirmative way using one of his/her terminals, then the alerting is ended and the end user joins the session.

This response leads to the alerting being aborted and not continuing to bother the invited end user. This inviting to a session and responding when performed according to SIP is generally described in RFC 3261, “SIP: Session Initiation Protocol”, J Rosenberg, H Schulzrinne, G. Camarillo, A. Johnston, J. Peterson, R. Sparks, M. Handley and E. Schooler, The Internet Society, June 2002.

RFC 3841, “Caller Preferences for the Session Initiation Protocol (SIP)”, J Rosenberg, H Schulzrinne and P. Kyzivat, The Internet Society, August 2004, describes various data fields that may be provided in SIP invitation messages. According to this document a SIP invitation message may include a field that is called “Request_Disposition”. This field has the function of aborting alerting.

However, there are some situations where aborting of alerting may not be so simple for the invited end user because the system is not made for user interactions of this kind.

### SUMMARY

The present invention is therefore directed towards improving the handling of communication session invitations.

More particularly, the present invention is related to the aborting of session invitation alerting.

There are some situations where aborting of alerting may not be so simple for an end user being invited to a communication session via a group of end user terminals. In some cases the invited end user may wish a further device to receive the invitation to the session, i.e. a device that is not an end user terminal being used for alerting. The further device may here typically be a voice mail device. The invited end user then decides that a call forwarding or diversion is to be made. However, this does not involve an ending of sending of invitation messages from the communication session control device. In this situation the communication session control device will continue to alert the invited end user via his/her end user terminals according to the prioritizing scheme until either the end user answers or a time-out is reached i.e. that an alerting time has expired. The invited end user is alerted even though he/she has responded to the alerting in a deliberate way and thus given instructions on how the invitation is to be handled. This situation may be very annoying for the invited end user. If the alerting continues up till time-out it is also possible that the initiator of the session tires of sending the invitation to join the session and “hangs up” his/her end user terminal. Then the invited end user will not learn what information the session initiator wanted to convey. This may also be very annoying for the end user.

The present invention improves on this situation.

The situation is generally improved through providing a specialised response to an invitation message being sent according to an invitation prioritizing scheme regarding an invitation for an end user to join a communication session. The specialised response is provided through a response message that provides a selection of a group related device for involvement in the communication session. In this way sending of invitation messages according to the invitation prioritizing scheme can be disrupted and involvement of the group related device in the communication session can be initiated.

One object of the present invention is thus to provide a method for allowing end-user control of session notification in a communication session control device, which method improves the handling of communication session invitations.

This object is according to a first aspect of the present invention achieved through a method for allowing end-user control of session notification in a communication session control device of a communication network where an invitation for an end user to engage in a communication session is received, an invitation message that corresponds to the invitation is sent to a group of end user terminals according to an invitation prioritizing scheme and a response message is received from one of the end user terminals in the group as a response to the invitation message. The response message here provides a selection of a group related device to be involved in the communication session. Thereafter invitation messages according to the invitation prioritizing scheme are disrupted from being sent and involvement of the group related device in the communication session is initiated based on the received response message.

Another object of the present invention is to provide a communication session control device in a communication network that improves the handling of communication session invitations.

This object is according to a second aspect of the present invention achieved through a communication session control device in a communication network comprising at least one communication interface for communicating with other devices and terminals and a communication session control unit. The communication session control unit receives, via the communication interface, an invitation for an end user to engage in a communication session, sends, via the communication interface, an invitation message that corresponds to the invitation according to an invitation prioritizing scheme to a group of end user terminals and receives, from one of the end user terminals in the group via the communication interface, a response message as a response to the invitation message. The response message provides a selection of a group related device for involvement in the communication session. The communication session control unit disrupts sending of invitation messages according to the invitation prioritizing scheme and initiates involvement of the group related device in the communication session based on the received response message.

Yet another object of the present invention is to provide a computer program product on a data carrier comprising computer program code that makes a communication session control device of a communication network improve the handling of communication session invitations.

This object is according to a third aspect of the present invention solved through a computer program product on a data carrier for allowing end-user control of session notification in a communication session control device and comprising computer program code configured to make a communication session control device of a communication network, when the code is loaded into the device, receive an invitation for an end user to engage in a communication session, send an invitation message that corresponds to the invitation according to an invitation prioritizing scheme to a group of end user terminals and receive, from one of the end user terminals in the group, a response message as a response to the invitation message, where the response message provides a selection of a group related device for involvement in the communication session. The code furthermore makes the device disrupt sending invitation messages according to the invitation prioritizing scheme and initiate involvement of the group related device in the communication session based on the received response message.

Another object of the present invention is to provide a method for allowing end-user control of session notification in a communication network, which method improves the handling of communication session invitations.

This object is according to a fourth aspect of the present invention solved through a method for allowing end-user control of session notification in a communication network. In the method an invitation message for an end user to engage in a communication session is received in an end user terminal belonging to a group of end user terminals. This message is being sent by a communication session control device of the communication network according to an invitation prioritizing scheme for the group. In the method the end user terminal furthermore receives an end user selection of a group related device for involvement in the communication session and sends a response message as a response to the invitation message. The response message provides the selection of the group related device. This allows the communication session control device to disrupt sending invitation messages according to the invitation prioritizing scheme and instead initiate involvement of the group related device in the communication session.

Another object of the present invention is to provide an end user terminal in a communication network that improves the handling of communication session invitations.

This object is according to a fifth aspect of the present invention solved through an end user terminal in a communication network belonging to a group of end user terminals, and comprising a user input unit, a communication interface and a session activity selection unit. The session activity selection unit receives an invitation message for an end user to engage in a communication session via the communication interface. The invitation message has here been sent from a communication session control device of the communication network according to an invitation prioritizing scheme for the group of end user terminals. The session activity selection unit also receives an end user selection of a group related device for involvement in the communication session via the user input unit and sends a response message as a response to the invitation message via the communication interface and addressed to the communication session control device. The response message provides the selection of the group related device. This allows the communication session control device to disrupt sending invitation messages according to the invitation prioritizing scheme and initiate involvement of the group related device in the communication session.

Yet another object of the present invention is to provide a computer program product on a data carrier comprising computer program code that makes an end user terminal in a communication network improve the handling of communication session invitations.

This object is according to a sixth aspect of the present invention solved through a computer program product on a data carrier for allowing end-user control of session notification in a communication network and comprising computer program code that makes an end user terminal being associated with the communication network as well as belonging to a group of end user terminals receive an invitation message for an end user to engage in a communication session.

The invitation message has here been sent by a communication session control device of the communication network according to an invitation prioritizing scheme for the group of end user terminals. The code also makes the end user terminal receive an end user selection of a group related device for involvement in the communication session and send a response message as a response to the invitation message. The response message provides the selection of the group related device. This allows the communication session control device to disrupt sending invitation messages according to the invitation prioritizing scheme and initiate involvement of the group related device in the communication session.

A further object of the present invention is to provide a communication network that has improved handling of communication session invitations.

This object is according to a seventh aspect of the present invention solved through a communication network comprising a communication session control device and an end user terminal. The communication session control device has at least one first communication interface for communicating with other devices and terminals, and a communication session control unit. The communication session control unit receives an invitation for an end user to engage in a communication session via the first communication interface, sends, via the first communication interface, an invitation message that corresponds to the invitation according to an invitation prioritizing scheme to a group of end user terminals including the above-mentioned end user terminal and receives a response message as a response to the invitation message from the end user terminal via the first communication interface. The response message provides a selection of a group related device for involvement in the communication session and includes an indication to stop sending invitation messages. The communication session control unit disrupts sending of invitation messages according to the invitation prioritizing scheme and initiates involvement of the group related device in the communication session based on the received response message. The end user terminal includes a user input unit, a second communication interface and a session activity selection unit. The session activity selection unit receives the invitation message via the second communication interface, receives an end user selection of the group related device for involvement in the communication session via the user input unit, and sends the response message as a response to the invitation message via the second communication interface and addressed to the communication session control device.

The present invention has many advantages. It allows an end user to order the network to perform a diversion to a device of his or her choice. As this is done alerting is furthermore aborted. In this way the end user is relieved from being bothered with alerting signals after having selected a diversion. This can be very annoying if loud sounds are used and if the prioritizing scheme is extensive. Also a session initiator is relieved from having to wait for the results of end user selections in relation the invitation, which also saves him or her time. The functionality providing this in the network and end user terminal may be implemented through software. The production costs may therefore also be low.

According to variations of the present invention the response message also includes an indication to stop sending invitation messages. This has the advantage of lowering the amount of processing otherwise required in the communication network.

According to some variations of the present invention the group related device may be located based on a network setting or through the response message including a network identifier of the group related device. A network setting provides good network control of group related devices to which diversion is allowed to be made, while a network identifier in a response message provides greater end user flexibility.

According to other variations of the present invention, the response message may be a first message in a first set of messages directed towards redirection of communication sessions that includes a field indicating a stopping of sending invitation messages or a second message in a second set of messages indicating network errors and being specifically defined as selecting redirection of a communication session. The first response message can be applied as a general solution on all types of messages in the first set, while the second message can only be provided as a single type of response message in the second set.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 schematically shows a few elements of a communication network,

FIG. 2 shows a simplified block schematic of the communication sessions control device according to the present invention,

FIG. 3 schematically shows the contents of a prioritizing data base 12 including subscribers as well as end user terminals and prioritizing schemes associated with these subscribers,

FIG. 4 shows a simplified block schematic of one of the end user terminals according to the present invention,

FIG. 5 shows a flow chart of a number of method steps being performed in a method for allowing end-user control of session notification in the session control device,

FIG. 6 shows a flow chart of a number of method steps in a method for allowing end-user control of session notification being performed in said end user terminal,

FIG. 7A schematically shows a response message according to a first embodiment of the present invention, and

FIG. 7B schematically shows a response message according to a second embodiment of the present invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well-known devices, circuits, and methods are omitted so as not to obscure the description of the present invention with unnecessary detail.

The present invention is generally directed towards handling of communication session invitations. The invention is more particularly directed towards providing a higher degree of user friendliness in relation to session notification.

The present invention will now be described in more detail in the non-limiting example context of a communication network N that is here a Wide Area network. The network N is shown in FIG. 1. This network N may here include an IP multimedia Subsystem (IMS) for delivering Internet Protocol (IP) multimedia to mobile users. This subsystem of the network N may here operate according to SIP (Session Initiation Protocol) as described in RFC 3261, “SIP: Session Initiation Protocol”, The Internet Society, June 2002, which is herein incorporated by reference.

The IMS subsystem of the communication network N includes a communication session control device CSC 10, which is typically a device that implements the S-CSCF (Serving Call Session Control Function) functionality defined by 3GPP. This device 10 may typically be provided in the form of a server. The communication session control device 10 is connected to a prioritizing store or prioritizing data base 12 as well as to a service unit SU 14. In the network there is also a further device 22, which will be described in more detail shortly.

There are a number of other devices and terminals connected the network. Here a first, second and third end user terminal 16, 18 and 20, which terminals are here associated with one first end user or in this example rather with a first subscriber S1 which subscriber may be the first end user. Here these end user terminals are also denoted T1, T2 and T3. However, it is in fact possible that the first end user is another person than the subscriber. The end user terminals, which may furthermore be so called SIP enabled clients, may here furthermore be provided in a home network, such as in a small local area network. The end user terminals T1 16, T2 18 and T3 20 may thus be provided in the home of a subscriber. There is also another end user terminal 24, here denoted a session initiator terminal, being connected to the network N. This session initiator terminal 24 is here associated with a session initiator SI, i.e. with a person who wants to initiate a communication session, like a voice communication session, with the user who has access to the end user terminals 16, 18, 20.

The first, second and third end user terminals 16, 18 and 20 are here terminals that are associated with the first subscriber S1 and may be such things as a computer, a land-line phone, a cellular phone or even a set-top box for a television. The session initiator terminal 24 may also be any type of communication device like a computer or a phone.

In FIG. 1 there is only one communication session control device CSC 10 shown. This is a device being provided for handling communication sessions on behalf of the first subscriber S1. It should be realized that there may be many more such devices in the network N, for instance another such device provided for the session initiator SI. It is also possible that the communication session control device 10 actually functions as such for several other subscribers than the first subscriber S1. There may thus be several sessions being handled by the communication session control device 10. However, in order to provide a clearer description of the present invention this is not shown in FIG. 1. In the same manner there may be more than one service unit 14. It should also be realized that the service unit 14 is a functional unit, much as S-CSCF. It is therefore clear that this unit can be a part of the communication session control device 10. However in the example to be given it is provided as a separate device. The prioritizing database 12 includes communication setup data for several subscribers and will be described in more detail later.

The further device 22 that is in the present example a part of the network N is here a voice mail device 22 being associated with the first subscriber S1. This device 22 is here also denoted a non-notified device NND. The reason for this will be described shortly. In this example the further device 22 records messages that the end user can access later.

FIG. 2 shows a block schematic of one way in which the communication session control device 10 may be implemented. It here includes a communication bus B 26, to which a first communication interface CI 28 is connected. There is furthermore a processor PR 30 and a program memory M 32 connected to this bus 26. The program memory 32 here includes a computer program providing a communication control function when being run by the processor 30. Therefore the processor and program memory 32 combination is here furthermore also denoted a communication session control unit. It should here be realized that the device 10 may include several more units and functions. However they have here been omitted in order not to obscure the description of the present invention with unnecessary detail. It should also be realized that communication between the interface 28, processor 30 and memory 32 does not need to be provided through the use of a bus 26. They may for instance be directly connected to each other. The communication session control device may also include more communication interfaces.

A subscriber may have a number of different end user terminals, which an end user may use for communication with other end users via the communication network N. In order to be able to perform such communication, the network and then particularly the IMS subsystem of the network needs to keep track of which end user terminals are associated with a certain subscriber and how they may be reached. In case a session initiator SI wants to invite an end user to a communication session it is also necessary to keep track of an invitation prioritizing scheme defining in what way and how the various end user terminals are to be used for notification of the invitation to the session. The prioritizing scheme may set out such details such as in what order the end user terminals are to be used. Such a notification may also be termed alerting.

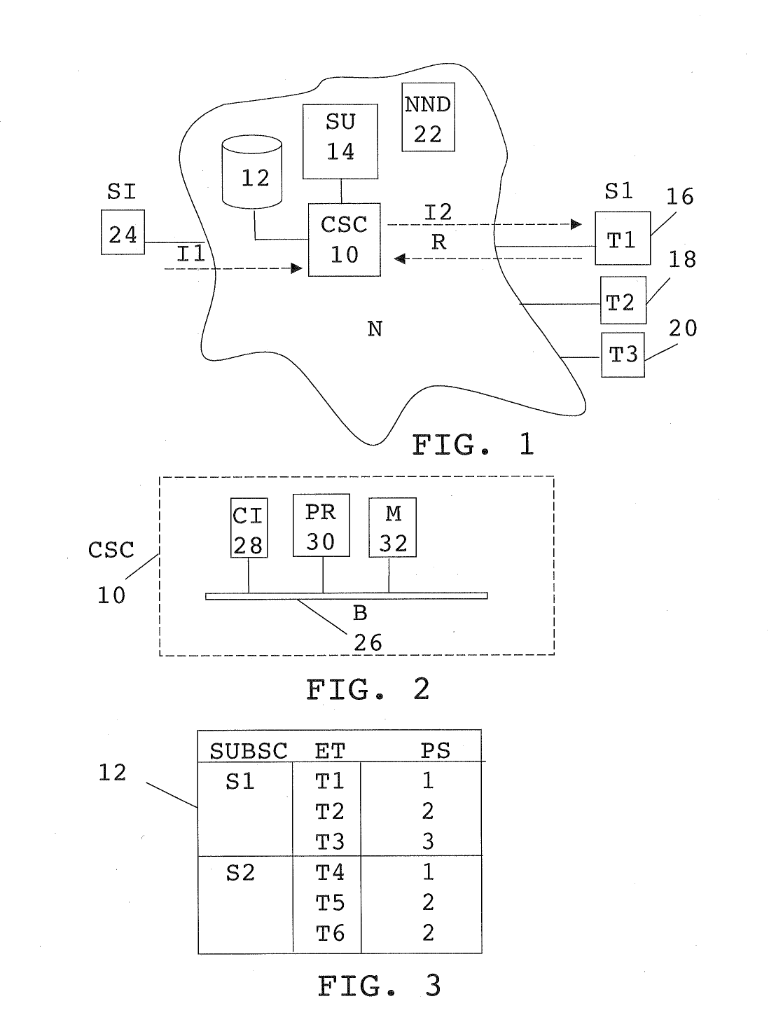

The prioritizing store or prioritizing database 12 includes such information for the different subscribers being handled by the communication session control device of the present invention. The content of this database 12 is shown in simplified form in FIG. 3. The database 12 here includes a table with three columns, a subscriber column SUBSC, an end user terminal column ET and a prioritizing scheme column PS. In the table there are entries made for different subscribers, where for the sake of simplicity only two subscribers, the first subscriber S1 and a second subscriber S2 are shown. For each subscriber there is provided a group of end user terminals as well as a prioritizing scheme. In FIG. 3 there are here three end user terminals in a group associated with the first subscriber S1. These end user terminals are here the first, second and third end user terminals T1, T2 and T3, The corresponding prioritizing scheme provides a priority setting of one for the first terminal T1, a priority setting of two for the second terminal T2 and a priority setting of three for the third terminal T3. This means that when the first end user having access to the end user terminals of the first subscriber S1 is invited to a communication session, he/she is first notified using the first end user terminal T1. If the first end user does not respond then he/she is notified using the second end user terminal T2 and finally using the third end user terminal T3. This process is also called forking. The just described prioritizing is one type of prioritizing. In the table there is also shown settings for the second subscriber S2. With this second subscriber S2 there are associated a fourth end user terminal T4, a fifth end user terminal T5 and a sixth end user terminal T6. These end user terminals have a different priority order. Here the fourth terminal T4 is used first, which is indicated with a priority setting of one, while the fifth and sixth terminals T5 and T6 are used for alerting in parallel which is indicated through them both having the priority setting of two. The prioritizing is here provided in a different way for the second subscriber S2. It should here be realized that also the first subscriber S1 may have a similar type of prioritizing scheme as the second subscriber S2.

It should also be realized that the invitation prioritizing schemes may be varied in many other different ways. More than two end user terminals may for instance have the same priority. It should also be realized that the table may also include network identifiers of the end user terminals, which may be a part of the definition of the terminal in question or may be provided as a separate field in the table. These identifiers are the identifiers used for connecting with the terminal and may be such things as IP-addresses. The table may furthermore include more data in respect of each subscriber. However, this has here been omitted in order to concentrate on the features that are relevant to the principles of the present invention.

According to the invention an end user may respond to an invitation to join a communication session in a special way. An end user terminal of an end user that may provide such a response is shown in schematic form in FIG. 4. This end user terminal is here exemplified by the first end user terminal 16, T1. The terminal 16 here includes a communication bus B 34, to which a second communication interface CI 36 is connected. There is furthermore a processor PR 38 and a program memory M 40 connected to this bus 34. The program memory 40 here includes a computer program providing a session activity selection function when being run by the processor 38. Therefore the processor 38 and program memory 40 combination is here furthermore also denoted a session activity selection unit. To the bus 34 there is also connected a user input unit K 42, which may be tactile and then provided in the form of a keyboard or a keypad. It is also possible to provide it in the form a remote control that is in wireless contact with the end user terminal, for instance via IR or Bluetooth communication. Finally there is in FIG. 4 connected a user output input D 44, which may be a display, presenting invitations to sessions and from where these invitations are originating. It should here be realized that as an alternative the user output unit 44 may be provided as a separate device with which the end user terminal is communicating. In one embodiment of the present invention the end user terminal is a set top box for a television set. In this case the user input unit may be a remote control, while the user output unit may be the screen of the television set.

It should here be realized that the end user terminal 16 may include several more units and functions. However they have here been omitted in order not to obscure the description of the present invention with unnecessary detail. The various units do furthermore not need to be interconnected via the bus, but can for instance have point to point connections with each other depending on which other units they need to communicate with. The end user terminal 16 may also include more communication interfaces.

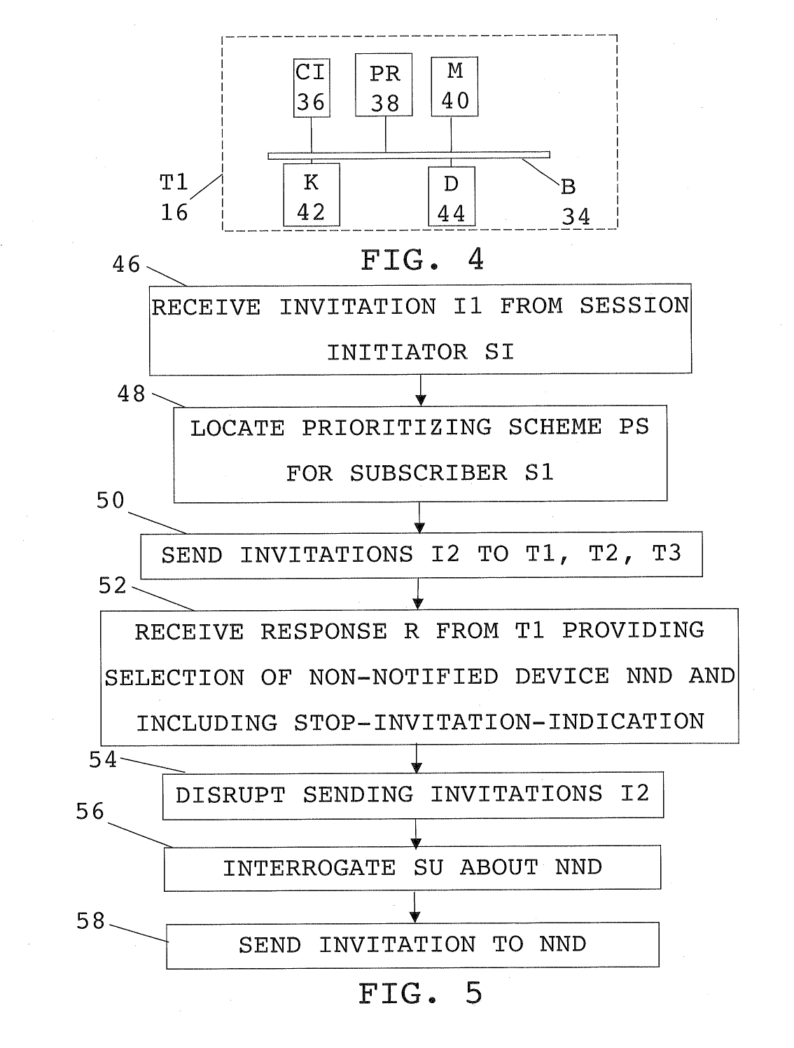

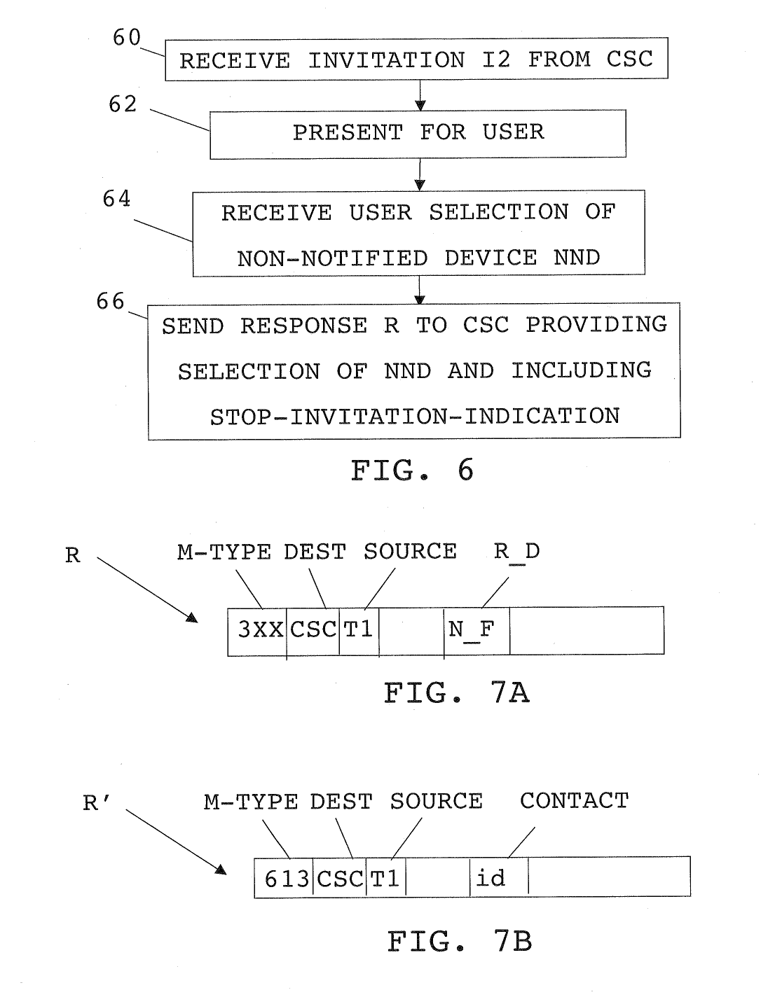

Now the functioning of the present invention will be described in more detail with reference being made to the previously described FIG. 1-4 as well as to FIG. 5, which shows a flow chart of a number of method steps being performed in a method for allowing end-user control of session notification in the session control device, and to FIG. 6, which shows a flow chart of a number of method steps in a method for allowing end-user control of session notification being performed in said end user terminal. The method steps in FIG. 5 are thus performed in the communication session control device and the method steps in FIG. 6 are performed in one end user terminal, which in the present example is the first end user terminal.

It all starts with the session initiator SI wanting to initiate a communication session involving the first end user who has access to the end user terminals 16, 18 and 20 of the first subscriber S1. The session initiator SI then sends an invitation I1 to the first end user from the session initiator terminal 24. This invitation may be sent as a SIP INVITE message according to the SIP specification and being addressed to one of the end user terminals of the first subscriber S1. As the invitation I1 is addressed to one of the end user terminals of the first subscriber S1 it will be forwarded through the network N to the communication session control device 10, which handles sessions for the first subscriber S1. This invitation I1 is shown as a dashed arrow in FIG. 1. The invitation I1 is thus received at the first communication interface 28 of the communication session control device 10 from where it is forwarded to the communication session control unit 30, 32. As the communication session control unit 30, 32 receives the invitation, step 46, it then has to determine in what way the first end user is to be notified of the invitation to the session. In order to do this it has to know which end user terminals that are associated with the first subscriber S1 and also the invitation prioritizing scheme to be used in the notification.

It therefore connects to the prioritizing store 12 or prioritizing database via the first communication interface 28, and locates or identifies all of the end user terminals that are associated with the first subscriber S1. More particularly the communication session control unit 30, 32 locates an invitation prioritizing scheme PS for the first subscriber S1, step 48. Here it locates the order and manner in which the end user terminals T1, T2 and T3 of the first subscriber S1 are to be notified about the session. This data is therefore fetched from the database 12 by the communication session control unit 30, 32 via the first communication interface 28.

Thereafter the communication session control unit 30, 32 notifies the first end user of the session to which he/she is invited. This is done through sending an invitation message I2 over the communication interface 28 to the group of end user terminals being associated with the first subscriber S1. It is thus sent to all the terminals 16, 18 and 20 of the first subscriber S1, step 50. This invitation message is furthermore sent according to the invitation prioritizing scheme. This means that, according to the exemplifying prioritizing scheme being depicted in FIG. 3, the invitation message I2 is first sent to the first end user terminal 16 during a first time-out period, followed by sending the same message to the second end user terminal 18 during a second time-out period followed by sending the invitation message I2 to the third end user terminal 20 during a third time-out period. The sending may here be performed through sending INVITE messages according to the principles set out in the SIP protocol.

According to this protocol alerting is finished if the user accepts to enter the session, which may be done through sending a response message in a set of messages directed towards this type of answer. This set is according to the SIP protocol the so-called 200-series of response messages. It is also possible for the first end user to send a busy signal, which may be done through sending a response message in another set of response messages that are used for indicating network errors. In SIP this set is the 600-series of response messages. When a response message according to any of these sets is sent, the communication session control device 10 will abort sending invitation messages and notify the session initiator SI that either the first end user is busy or that he/she will enter the session.

However, the first end user may wish to convey some other type of information or perform some other type of activity. The present invention is directed towards this situation.

The first end user may for instance select to divert the session, via one of the end user terminals 16, 18 or 20, so that a further device engages in the session on behalf of the user. This diversion may also be considered to be call forwarding. The diversion may be needed if for instance the end user terminal in question on which alerting is being performed is not equipped with functionality for handling a session, which may be the case if the terminal is for instance a set top box. The first end user may of course also select to divert the session for other reasons. The device to which diversion is made may for instance be one of the end user terminals that are provided in the group, for instance one that has a low priority in the invitation prioritizing scheme. However, it may also be a completely other device, like an end user terminal belonging to another subscriber or a device provided in the network N, like the voice mailbox device 22. The device to which diversion is to be made can thus be considered as a group related device or a device that is related to the group of end user terminals. With the expression “group related device” is meant that the device can be included in the group or that it is associated with the group, for instance through acting as a mail box for all the end user terminals in the group. The further device 22 is a device that cannot receive the invitation messages 12 since it is not provided in the group of the first subscriber S1. This device 22 is therefore also denoted a non-notified device NND. Another type of non-notified device that could be selected is an end user terminal that is provided in the group of the first subscriber S1 but has not yet received the invitation message I2, i.e. it has a low priority.

As the second invitation message I2 is sent to the end user terminals 16, 18 and 20 of the first subscriber S1 according to the invitation prioritizing scheme PS it is here as an example first sent to the first end user terminal T1 16, which is thus here a set top box. The sending of this message I2 is shown as a dashed arrow in FIG. 1. The terminal T1 16 thus here receives the invitation message I2 from the communication session control device CSC 10 on the second communication interface 36, from where it is forwarded to the session activity selection unit 38, 40. The session activity selection activity unit 38, 40 thus receives the message I2, step 60, and then presents the invitation for the user on the user output unit 44, step 62, and receives a selection from the user in relation to the invitation, step 64.

In case the selection was a selection of the user being busy the session activity selection unit 38, 40 may send a response signal in the 600-series as a response to the communication session control device 10. However, if the selection involves a diversion of the session to a non-notified device NND like the further device 22, then the session activity selection unit 38, 40 sends a response message R to the communication session control device CSC 10 via the second communication interface 36 as a response to the invitation message I2, step 66, which response message according to the principles of the present invention provides a selection of a group related device, i.e. of a device associated with the group of terminals of the first subscriber S1, and includes an indication to stop sending invitations. The response message R thus provides a selection of a further device which is to engage in the session on behalf of the user, which device in the present example is the further non-notified device NND 22 that is a voice mail device, as well as includes an indication that the communication session control device 10 is to stop alerting the first user, i.e. to disrupt sending invitation messages I2 according to the invitation prioritizing scheme. The response message R is in FIG. 1 indicated with a dashed arrow. The sending of the response message R thus signals to the communication session control device 10 that it is to stop sending invitation messages I2 to the second and third end user terminals T2 and T3.

According to the SIP protocol, diversion related response messages are provided in a set of messages called the 300-series. However, a communication session control device operating according to the SIP protocol cannot abort sending invitation messages when receiving this known response message. Before it can process response messages of this type, it has to send invitations to all end user terminals of the prioritizing scheme. This is both time-consuming and annoying to both the first end user and the session initiator SI.

According to the present invention the above-described response message is a special response message. What the special response message may look like will shortly be described in more detail.

The response message R is received by the communication session control unit 30, 32 of the communication session control device 10 via the first communication interface 36, step 52. Which response R thus at least indicates a non-notified device that is to enter the session as well as includes an indication that invitations are to be stopped to be sent. In the present example there is only an indication of the fact that a further non-notified device is to be joining the session instead of any of the end user terminals 16, 18 and 20 of the first subscriber S1. The identity of the further device is here not yet known. Based on or in dependence of the reception of the received response message R, the communication session control unit 30, 32 then disrupts sending invitation messages I2 to the end user terminals 16, 18 and 20 of the first subscriber S1, step 54.

Thereafter it interrogates, via the first communication interface 28, the service unit SU 14 about which devices that are to be connected to sessions in diversions in relation to the first subscriber S1, step 56. The service unit SU 14 returns a response that points out the further device 22, which response may be limited to non-notified devices NND. The service unit 14 therefore provides a network setting of a device to which diversion is to be made for the first subscriber S1 and the communication session control unit 30, 32 thus locates the further device 22 based on this network setting. After the receipt of the response, the communication session control unit 30, 32 then initiates involvement of the further device 22 in the communication session. This is done through sending out an invitation to this further device 22 for joining the session via the first communication interface 28, step 58. The further device 22 may now enter the session. Since the further device 22 in this example is a voice mail box device, the session initiator SI may now record a voice message for the user in the voice mail box device 22.

The response message may according to a first embodiment of the present invention be a modified response message in a set of messages directed towards redirection of communication sessions. In SIP these messages are the 300-set of messages such as messages 301 and 302. A message in this set is schematically shown in FIG. 7A. Here the type of message is indicated through the symbol 3XX. This is used in order to indicate that the principles of the present invention can be applied on any of the existing messages in this set. The message in FIG. 7A here includes a message type field M-TYPE, which here thus shows that it is a message of the 300-type, a destination identifier DEST, i.e. an IP-address of the communication session control device CSC as well as a source field SOURCE including an identifier of the end user terminal T1 itself. These fields are normally provided in this type of message. According to the first embodiment of the present invention the message R also includes a further field, which is a field R_D indicating a stopping of sending invitation messages. According to one variation of the present invention this field is a field denoted “Request_Disposition”, which is normally provided in invitation messages sent from session initiators and which has the function of aborting alerting. This field is described in more detail in RFC 3841, “Caller Preferences for the Session Initiation Protocol (SIP)”, J Rosenberg, H Schulzrinne and P. Kyzivat, The Internet Society, August 2004, which is herein incorporated by reference. According to the present invention this field is thus used in response messages to session invitations and then in any response message in the 300-series. The field R_D here includes a selection or a flag N_F named No_Forking, which specifies that alerting is to be aborted.

Communication sessions to which invitations can be made may be any type of multimedia sessions, like for instance voice communication sessions, like VoIP sessions, video communication sessions. These sessions may furthermore include various types of conference communication sessions.

The present invention that has been described so far has a number of advantages. It allows the first end user to order the network to perform a diversion to a device for which there exists a network setting. As this is done alerting is furthermore aborted. In this way the first end user is relieved from being bothered with alerting tones after having selected a diversion. This can be very annoying if loud sounds are used and if the invitation prioritizing scheme is extensive. Also the session initiator is relieved from having to wait for the results of the first end user selections in relation to the invitation, which also saves him/her time. As the functionality providing this in the network and end user terminal may be provided through software, the production costs for implementing the present invention are furthermore low. The use of a network setting that determines which device diversion is to be made to furthermore allows the provision of good network control of which devices to which diversion is allowed to be made. The use of a modified response message in a set of messages directed towards redirection of communication sessions has the further advantage of being applicable as a general solution on all messages in the set.

An alternative type of response message R′ according to a second embodiment of the present invention is shown in FIG. 7B. This message R′ is a message in a set of messages indicating network errors. In SIP this set is the 600-set. According to this second embodiment of the present invention there is created one message type in this set that does not previously exist, like for instance one named 613. This message is then given a special meaning, i.e. a meaning that the message involves a selection of a diversion of a communication session. This message thus includes a message type field M-TYPE, which in this example is 613, and destination and source fields DEST and SOURCE with data CSC and T1 as in FIG. 7A. There is here finally a contact field CONTACT, which field naturally appears in these types of messages. In this second embodiment of the present invention this contact field CONTACT includes a network identifier id, which is here the network identifier or IP address of the device to which diversion is to be made, i.e. the network identifier of the further device 22 in FIG. 1 in the present example. This network identifier id may here have be entered into the contact field CONTACT of the response message R′ by the session activity selection unit based on first end user inputs via the user input unit. The first end user may thus here directly select device to which diversion is to be made. As the communication session control unit 30, 32 of the communication session control device 10 receives this message R′, it investigates the message type field M-TYPE. As the message is a message in the 600-series the communication session control unit 30, 32 first of all disrupts sending of invitation messages to the end user terminals. This is done in accordance with the standard procedure for handling response messages in the 600-series. However, it does not return an error message or busy signal to the session initiator. Instead it notes that this message is a message that involves a diversion of the communication session through noting the special message type code 613. This code signals that the session invitation should be answered in a special way. Therefore it performs diversion. Here it furthermore sends the invitation to the further device identified by the identifier id in the contact field CONTACT of the response message R′.

It should here be stressed that the code 613 is just one example of a code that can be used. What is important is that the code is new and does not previously exist for ordinary network type errors.

The use of the contact field in the above-described way has the advantage of allowing the user even more freedom and ease in the selection of to which device diversion is to be made. The use of a response message in a set of messages indicating network errors can only be provided as a single type of response message in the set. It can thus not be provided as a general solution. This may be of advantage if the changes to messages in order to implement the present invention are to be kept as limited as possible.

It should here be realized that also the message R in FIG. 7A can be modified so that it uses the contact field in the same way as is done in the second embodiment and that thus the identity of the further device can be obtained through data sent by the end user terminal of the first end user. It should also be realized that the contact field of the return message in FIG. 7B may not be used, but that the communication session control device instead interrogates the service unit in the network about the identity like in the first embodiment.

According to another variation of the invention, the communication session control device, the service unit or both the communication session control device and service unit may keep track of the session involvement abilities of the end user terminals. One or both of them may for instance know that the first end user terminal is a set-top box that has no session involvement ability at all. In this case he response message does not need to include an indication to stop sending invitation messages. The invitation message being sent to the set-top box would then be a specialized invitation message providing the option for the end user to select diversion to the further device. The response message may then be a simple confirmation that diversion is to be made and the session control device or service unit may then locate the further device in the way described in relation to FIG. 7A. Alternately the further device may be located in the way described in relation to FIG. 7B.

There are a number of modifications that can be made to the present invention apart form those already mentioned. Invitation prioritizing schemes and end user terminals were above described in relation with a subscriber. Such a subscriber can be a physical person but also a legal person. As an alternative it is furthermore possible that the end user terminals are directly associated with an end user instead of with a subscriber. Diversion was above generally described as being made to a device, which was associated with a user or a subscriber, but not provided in the group of end user terminals of this subscriber or end user. As mentioned earlier this device may be a non-notified device and thus include end user terminals in the group that have not yet been notified. However it is furthermore possible that diversion is made to any device, including all end user terminals in the group notified and non-notified as well as to devices not belonging to the user/subscriber, like for instance end user terminals belonging to a completely different user or subscriber.

Finally the relevant parts of the communication session control device and end user terminal of the present invention were realized in the form of a processor with associated program memory including computer program code for performing the functionality of the communication session control unit and session activity selection unit. It should be realized that these units may also be provided in the form of hardware, like for instance in the form of ASIC circuits. The computer program code may also be provided on a data carrier, like a CD Rom disc or a memory stick, which will implement the function of the corresponding unit when being loaded into a server or end user terminal.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the present invention is only to be limited by the following claims.

1-21. (canceled)

22. A method performed in a communication session control device of a communication network for allowing end user control of session notification, the method comprising:
receiving an invitation for an end user to engage in a communication session;
sending an invitation message that corresponds to said invitation according to an invitation prioritizing scheme to a group of end user terminals;
receiving from one of said end user terminals in the group, a response message as a response to the invitation message, said response message providing an end user selection of a group related device for involvement in the communication session; and
responsive to receiving the response message, disrupting sending invitation messages according to the invitation prioritizing scheme, and initiating involvement of said group related device in the communication session.

23. The method according to claim 22, wherein said response message includes an indication to stop sending invitation messages.

24. The method according to claim 22, further comprising the step of locating said invitation prioritizing scheme that defines how said end user is to be invited via said group of end user terminals.

25. The method according to claim 22, further comprising locating the group related device based on a network setting of at least one group related device to which redirection is to be performed.

26. The method according to claim 22, wherein said response message includes an identifier identifying said group related device in the communication network.

27. The method according to claim 22, wherein said response message comprises a message in a set of messages directed towards redirection of communication sessions and includes a field indicating a stopping of sending invitation messages.

28. The method according to claim 22, wherein said response message comprises a message in a set of messages indicating network errors and being defined as selecting redirection of a communication session.

29. A communication session control device in a communication network, said communication session control device comprising:
at least one communication interface for communicating with other devices and terminals; and
a communication session control unit configured to:
receive, via said communication interface, an invitation for an end user to engage in a communication session;
send, via said communication interface, an invitation message that corresponds to said invitation according to an invitation prioritizing scheme to a group of end user terminals;
receive, from one of said end user terminals in the group via said communication interface, a response message as a response to the invitation message, said response message providing an end user selection of a group related device for involvement in the communication session; and
responsive to said received response message, disrupt sending invitation messages according to the invitation prioritizing scheme, and initiate involvement of said group related device in the communication session.

30. The communication session control device according to claim 29, wherein the communication session control unit is further configured to locate, in a prioritizing store, said invitation prioritizing scheme that defines how said end user is to be invited via said group of end user terminals.

31. The communication session control device according to claim 29, wherein the communication session control unit is further configured to locate the group related device based on a network setting of at least one group related device to which redirection is to be performed.

32. A computer program product on a data carrier for allowing end-user control of session notification in a communication session control device and comprising non-transient computer program code loaded into a communication session control device and configured to:
receive an invitation for an end user to engage in a communication session;
send an invitation message that corresponds to said invitation according to an invitation prioritizing scheme to a group of end user terminals;
receive from one of said end user terminals in the group, a response message as a response to the invitation message, said response message providing an end user selection of a group related device for involvement in the communication session; and
responsive to receiving the response message, disrupt sending invitation messages according to the invitation prioritizing scheme, and initiate involvement of said group related device in the communication session.

33. A method for allowing end-user control of session notification in a communication network, the method comprising:
receiving, in an end user terminal belonging to a group of end user terminals, an invitation message for an end user to engage in a communication session, said invitation message being sent by a communication session control device of the communication network according to an invitation prioritizing scheme for said group;
receiving an end user selection of a group related device for involvement in the communication session; and
sending a response message as a response to the invitation message, said response message providing the selection of said group related device, in order to allow said communication session control device to disrupt sending invitation messages according to the invitation prioritizing scheme, and initiate involvement of said group related device in the communication session.

34. The method according to claim 33, wherein said response message includes an indication to stop sending invitation messages.

35. The method according to claim 33, wherein said response message includes an identifier identifying said group related device in the communication network.

36. The method according to claim 33, wherein said response message comprises a message in a set of messages directed towards redirection of communication sessions and includes a field indicating a stopping of sending invitation messages.

37. The method according to claim 33, wherein said response message comprises a message in a set of messages indicating network errors and being defined as selecting redirection of a communication session.

38. The method according to claim 33, wherein said end user terminal comprises a set-top box and said group related device comprises a voice mail device.

39. An end user terminal in a communication network belonging to a group of end user terminals, said end user terminal comprising:
a user input unit;
a communication interface; and
a session activity selection unit configured to:
receive, via said communication interface, an invitation message for an end user to engage in a communication session, said invitation message being sent from a communication session control device of the communication network according to an invitation prioritizing scheme for said group of end user terminals;
receive, via said user input unit, an end user selection of a group related device for involvement in the communication session; and
send a response message as a response to the invitation message, via said communication interface and addressed to said communication session control device, said response message providing the selection of said group related device, in order to allow said communication session control device to disrupt sending invitation messages according to the invitation prioritizing scheme and initiate involvement of said group related device in the communication session.

40. The end user terminal according to claim 39, wherein the end user terminal comprises a set-top box and said group related device comprises a voice mail device.

41. A computer program product on a data carrier for allowing end-user control of session notification in a communication network and comprising non-transient computer program code loaded into an end user terminal that is associated with the communication network and belongs to a group of end user terminals, said computer program product configured to:
receive an invitation message for an end user to engage in a communication session, said invitation message being sent by a communication session control device of the communication network according to an invitation prioritizing scheme for said group of end user terminals;
receive an end user selection of a group related device for involvement in the communication session; and
send a response message as a response to the invitation message, said response message providing the selection of said group related device, in order to allow said communication session control device to disrupt sending invitation messages according to the invitation prioritizing scheme, and initiate involvement of said group related device in the communication session.

42. A communication network comprising
a communication session control device comprising:
at least one first communication interface for communicating with other devices and terminals; and
a communication session control unit configured to:
receive, via said at least one first communication interface, an invitation for an end user to engage in a communication session;
send, via said at least one first communication interface, an invitation message that corresponds to said invitation according to an invitation prioritizing scheme to a group of end user terminals;
receive, from one of said end user terminals in the group via said first communication interface, a response message as a response to the invitation message, said response message providing an end user selection of a group related device for involvement in the communication session and an indication to stop sending invitation messages; and
responsive to said received response message, disrupt sending invitation messages according to the invitation prioritizing scheme, and initiate involvement of said group related device in the communication session; and
at least said one of said end user terminals comprising:
a user input unit;
a second communication interface; and
a session activity selection unit configured to:
receive, via said second communication interface, said invitation message;
receive, via said user input unit, an end user selection of the group related device for involvement in the communication session; and
send said response message as a response to the invitation message, via said second communication interface and addressed to said communication session control device.
